(19) United States
(12) Patent Application Publication
(10) Pub. No.: US 2006/0062305 A1
(43) Pub. Date: Mar. 23, 2006

(54) Method for block-matching motion estimation with effective computation while small motion movement

(75) Inventors: Ai-Chieh Lu, Yonghe City (TW); Yueh-Yi Wang, Taichung City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Primax Electronics Ltd., Taipei (TW)

(21) Appl. No.: 10/991,114

(22) Filed: Nov. 17, 2004

(30) Foreign Application Priority Data
Sep. 17, 2004 (TW) 093128347

(51) Int. Cl. H04N 11/02; H04N 11/04; H04N 7/12; H04B 1/66

(52) U.S. Cl. 375/240.16; 375/240.24

(57) ABSTRACT

A block matching motion estimation method for obtaining a motion vector between a macro block in a current frame and a best match block in a reference frame is provided. The block matching motion estimation method includes steps of dividing a search window of the reference frame into a first area, a second area and a third area, wherein the first area is located between the second area and the third area, and searching initially from the first area for the motion vector.

### FIELD OF THE INVENTION

The present invention relates to a method for block matching in the motion estimation, and more particularly to a method for block matching in the motion estimation with an effective computation for a small motion movement.

### BACKGROUND OF THE INVENTION

The motion estimation is often used for processing dynamic digital images, such as images shot with a digital camera. For example, the motion estimation can be used for hand-shaking compensation in the digital image compression system and the digital image stabilization system (DIS). The so-called motion estimation is used for calculating the motion vector between the frames, which is obtained from successive shoots, to eliminate the redundancies of frames in the time domain. For instance, MPEG (Motion Picture Experts Group), the most well-known dynamic image compression standard at present, employs the motion vector to compress and encode images.

In order to obtain the motion vector between the frames, it needs to proceed the block matching therebetween. The block matching is performed by finding a best match block within a specific search window of a previous frame, which corresponds to a specific block within the frame to be encoded, so as to obtain the motion vector for the specific block. The details of the block matching are illustrated as follows.

Please refer to FIG. 1, which shows the relationship between the reference frame and the current frame using the block matching technique. As shown in FIG. 1, the movement of an object is divided into a plurality of frames in the time domain, including the reference frames 11, 12 and the current frame 13. The reference frame 11 is previous to the reference frame 12, and the reference frame 12 is previous to the current frame 13. The block matching is proceeded within the predetermined search windows 111, 121 and 131 so that the size of the search window has to be greater than that of the block. In order to proceed the block matching, each frame is divided into a plurality of blocks, in which each block has a size of M*N (usually 16*16) pixels. These blocks are termed as macro blocks. The data stored for the current frame 13 is mainly the difference between the current frame 13 and reference frame 12. Through adopting the motion estimation technique, the image data that is needed to be stored is greatly reduced. The current frame 13 is composed of plural macro blocks. In theory, each macro block in the current frame 13 can be found in the reference frame 12. The block matching is used to find the best match macro block in a certain area of the reference frame 12. In other words, the found macro block of the reference frame 12 is also the most similar to the macro block in the current frame 13. Only the displacement of the best match macro block between the reference frame 12 and current frame 13, i.e. the motion vector (MV), and the difference therebetween need to be recorded if the best match macro block is found during the block matching.

At present, there are many ways to perform the block matching, such as the Full search, the Two-step search, the Three-step search, the Four-step search, the Diamond search, the N-step search and so on. In addition, there are also many functions for determining if the macro block in the current frame 13 is the most approximative one to the corresponding macro block in the reference frame 12, such as functions of the mean of absolute error (MAE), the sum of absolute difference (SAD) and so on. The value calculated from MAE or SAD is generally called as the cost function. SAD is the most common way to be performed for the cost function calculation. In another word, The best match macro block will be found as the minimum SAD value occurs in the block matching. SAD calculation is applied in MPEG-1, MPEG-2 and MPEG-3, so the present invention will be illustrated with the use of SAD calculation. The N-step search is exemplified as follows.

Please refer to FIG. 1 and FIG. 2. FIG. 2 shows the N-step search for the block matching in the prior art, wherein the size of the search window 121 is of 32*32 pixels. The steps involved in the N-step search are as follows.

1. At first, a sampling point A located in the center of the search window 121 is based. Then, another eight sampling points are spread, which center around the sampling point A, so as to form a first search area 21. Each of the nine sampling points in the first search area 21 is spaced out from each other by five pixels. Next, the SAD calculation of M*N (usually 16*16) pixels for each of the nine sampling points in the first search area 21 is proceeded to obtain the sampling point B having a minimum SAD value among the nine sampling points therein.

2. The sampling point B is based, and then another eight sampling points are spread, which center around the sampling point B, so as to form a second search area 22. Each of the nine sampling points in the second search area 22 is spaced out from each other by four pixels. Afterwards, the SAD calculation of M*N pixels for each of the nine sampling points in the second search area 22 is proceeded to obtain the sampling point C having a minimum SAD value among the nine sampling points therein.

3. The sampling point C is based, and then another eight sampling points are spread, which center around the sampling point C, so as to form a third search area 23. Each of the nine sampling points in the third search area 23 is spaced out from each other by three pixels. Afterwards, the SAD calculation of M*N pixels for each of the nine sampling points in the third search area 23 is proceeded to obtain the sampling point D having a minimum SAD value among the nine sampling points therein.

4. The sampling point D is based, and then another eight sampling points are spread, which center around the sampling point D, so as to form a fourth search area 24. Each of the nine sampling points in the fourth search area 24 is spaced out from each other by two pixels. Afterwards, the SAD calculation of M*N pixels for each of the nine sampling points in the fourth search area 24 is proceeded to obtain the sampling point E having a minimum SAD value among the nine sampling points therein.

5. The sampling point E is based, and then another eight sampling points are spread, which center around the sampling point E, so as to form a fifth search area 25. Each of the nine sampling points in the fifth search area 25 is spaced out from each other by one pixel. Afterwards, the SAD calculation of M*N pixels for each of the nine sampling points in the fifth search area 25 is proceeded to obtain the sampling point F having a minimum SAD value among the nine sampling points therein. Accordingly, the motion vector for the corresponding macro block in the search window 131 can be obtained.

Each of the conventional block matching techniques has its characteristic. For example, speaking of the hardware complexity in practice, the N-step search is better than the Two-step search. But when it comes to the image quality, the Full-search is the best, the Two-step search and Diamond search are inferior and the N-step search is the worst. However, speaking of the searching speed, the Diamond search is the best, the N-step search is inferior and the Two-step search is the worst. In other words, there are many different kinds of block matching techniques in the prior art, and the user can choose the optimal one according to the practical demand. For instance, it is necessary to choose the block matching technique that produces better image quality for the application of image compression and decompression under MPEG standard. Nevertheless, it is better to choose the block matching technique having a faster searching speed and a lower hardware complexity for the purpose of saving system resources.

Although there are many block matching techniques in the prior art, they are mostly designed for the purpose of image compression. So far, there are no block matching techniques designed for the purpose of DIS for hand-shaking compensation.

As previously said in the background, a digital image stabilization system (DIS) is typically applied for the hand-shaking compensation for various digital cameras. Since hand-shaking by the user who holds the digital camera during the image-shooting is unpreventable, the hand-shaking compensation has become an important function for most digital cameras for compensating the influence thereof on the image data.

In the digital camera system, a typical DIS processing system includes four parts described as follows.
(1) The local motion vector (LMV) unit.

In the motion vector estimation, each frame is divided into a plurality of small blocks. The LMV unit is used for performing the motion estimation for the images of the small blocks in each frame. The motion vector for each small block in the frame is termed as the local motion vector.

(2) The frame motion vector (FMV) unit.

The frame LMV unit is used for calculating the motion vector for each frame according to the local motion vector calculated by the LMV unit.

(3) The motion smooth (MS) unit.

The MS unit is used for calculating the smoothing target motion vector (SFMV) according to a series of motion vectors for the frames calculated by the frame LMV unit. This indicates that the image with the FMV is unstable, but the image with the SFMV is stable.

(4) The motion compensation (MC) unit.

The MC unit is used for compensating for each frame based on the SFMVs.

Generally, the block matching techniques respectively for the image compression and for DIS have the following differences.

(1) The DIS needs correct motion vectors.

(2) Because the purpose of DIS is to measure the movement rather than the image, it doesn't need the motion vector for each block. In other words, only the motion vectors for a few blocks in the frame are needed to be calculated. However, in the application for the purpose of image compression, the compressed images have to be reconstructed. Therefore, the motion vector for each block in the frame has to be calculated and obtained in the motion vector estimation for image compression, e.g. MPEG.

Hence, the present invention provides a block matching technique exclusively designed for the above characteristics of DIS for the hand-shaking compensation.

### SUMMARY OF THE INVENTION

In accordance with one aspect of the present invention, a block matching motion estimation method is provided. The method is especially applied to the digital image stabilization system.

In accordance with another aspect of the present invention, a block matching motion estimation method is provided. The method can reach the balance between the searching speed and image quality. Especially, the motion vector generated by the method of the present invention is extremely suitable for use in the process of dynamic images during horizontal movement, such as the hand shaking compensation for the digital camera while shooting.

In accordance with further aspect of the present invention, a block matching motion estimation method is provided. The method divides the search window into three areas and starts the search with the center area so as to shorten the operation time.

In accordance with further another aspect of the present invention, a block matching motion estimation method for obtaining a motion vector between a macro block in a current frame and a best match block in a reference frame is provided. The block matching motion estimation method comprises steps of dividing a search window of the reference frame into a first area, a second area and a third area, wherein the first area is located between the second area and the third area, and searching initially from the first area for the motion vector.

Preferably, the reference frame and the current frame respectively include a plurality of macro blocks.

Preferably, the current frame is subsequent to the reference frame in the time domain.

Preferably, the search window of the reference frame has a size greater than that of the macro block in the current frame.

Preferably, the first area has a size greater than one of those of the second area and the third area.

Preferably, the search step for the motion vector includes sub-steps of (a) finding a sampling point A having a minimum value of a cost function in the first area, (b) determining whether the sampling point A is a sampling point having a minimum value of a cost function in the search window according to a plurality of judging criteria, (c) calculating each sampling point within a first square block of O*P pixels which centers around the sampling point A if the judging criteria are satisfied to obtain a sampling point A1 having a minimum value of a cost function within the first square block of O*P pixels so as to obtain the motion vector, (d) finding a sampling point B having a minimum value of a cost function in the second area and a sampling point C having a minimum value of a cost function in the third area if the judging criteria are not satisfied, (e) obtaining a final sampling point from the sampling point A, the sampling point B and the sampling point C, wherein the final sampling point has a minimum value among the minimum value of the cost function of the sampling point A, the minimum value of the cost function of the sampling point B and the minimum value of the cost function of the sampling point C, and (f) calculating each sampling point within a second square block of O*P pixels which centers around the final sampling point to obtain a sampling point F having a minimum value of a cost function within the second square block of O*P pixels so as to obtain the motion vector.

Preferably, the step (a) is performed by spreading a sampling point every X pixels in the first area and then calculating a sum of absolute difference (SAD) of M*N pixels for each sampling point in the first area so as to obtain the sampling point A having the minimum value of the cost function.

Preferably, A is equal to 4.

Preferably, M and N are both equal to 16.

Preferably, the judging criteria include the minimum value of the cost function of the sampling point A being less than a first threshold value, and a value of a y component of a motion vector of the sampling point A being less than a second threshold value.

Preferably, the judging criteria further include a motion vector between the reference frame and another macro block adjacent to the macro block in the current frame extremely approaching zero.

Preferably, O and P are both equal to 7.

Preferably, the step (d) is performed by spreading a sampling point every X pixels in the second area and then calculating a sum of absolute difference (SAD) of M*N pixels for each the sampling point in the second area so as to obtain the sampling point B having the minimum value of the cost function.

Preferably, the step (d) is performed by spreading a sampling point every X pixels in the third area and then calculating a sum of absolute difference (SAD) of M*N pixels for each sampling point in the third area so as to obtain the sampling point C having the minimum value of the cost function.

In accordance with further another aspect of the present invention, a digital image stabilization system having a block matching motion estimation method executed therein for obtaining a motion vector between a macro block in a current frame and a best match block in a reference frame is provided. The digital image stabilization system is characterized in that the reference frame has a search window divided into a first area, a second area and a third area, wherein the first area is located between the second area and the third area, and a search for the motion vector is initially performed from the first area.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows the relationship between the reference frame and the current frame for the block matching technique in the prior art;

FIG. 2 schematically shows the steps of the N-step search in the prior art;

FIGS. 3(a)˜3(g) shows the steps of the block matching method according to a preferred embodiment of the present invention;

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

For the most part, the block matching method of the present invention is to divide the search window of the reference frame into three areas and start the block matching with the center area. If the corresponding macro block which is most similar to the macro block in the current frame has been found in the center area (according to the judging criteria set by the present invention), the block matching will be finished. If not, the block matching for the other two areas will be proceeded.

The reason why the present invention is applied to the hand shaking compensation for DIS is that the camera is usually in a horizontal movement while being operated by the user. Thus, it is reasonably conjectured that image variation in the center of the frame is always larger than that in other areas of the frame. Accordingly, the best match macro block can be found precisely and rapidly if the block matching starts with the center area of the search window. If the best match macro block for calculating the motion vector is found in the center area of the search window, the search for the other two areas can be omitted.

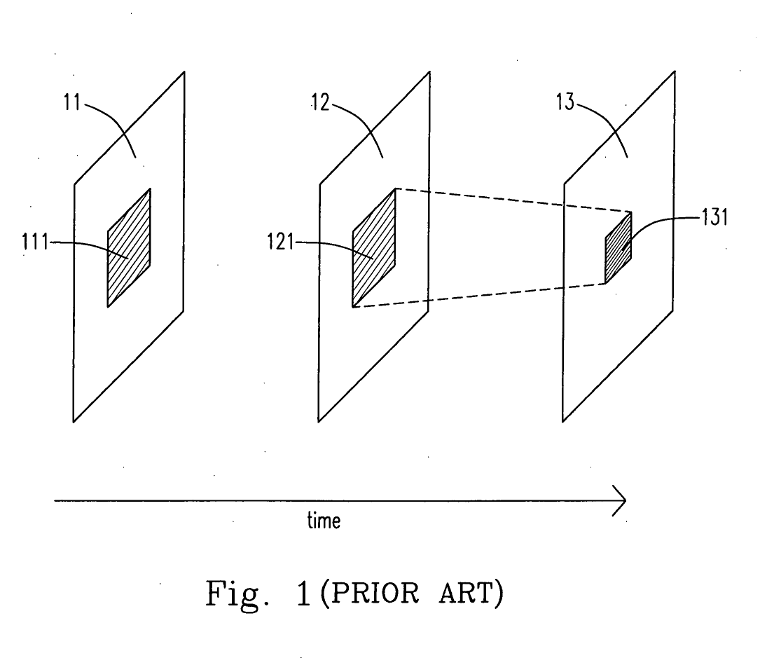

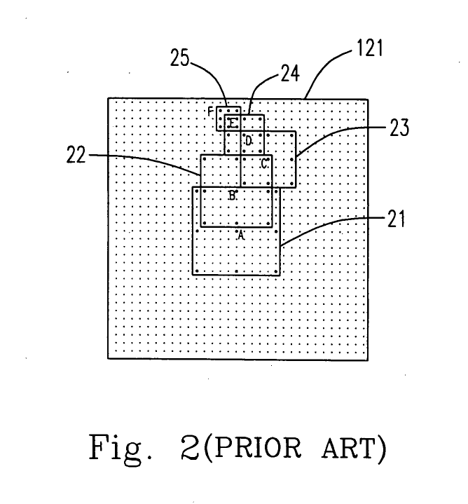

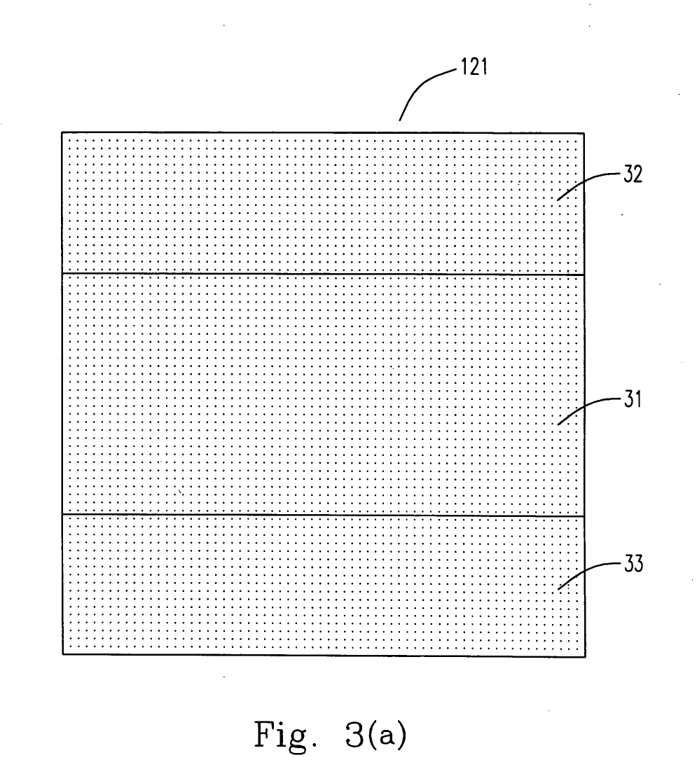

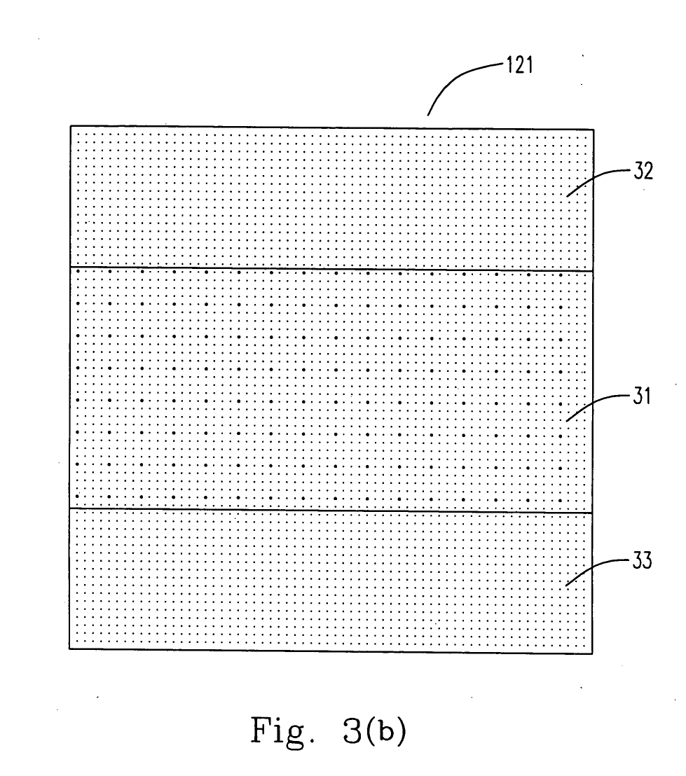

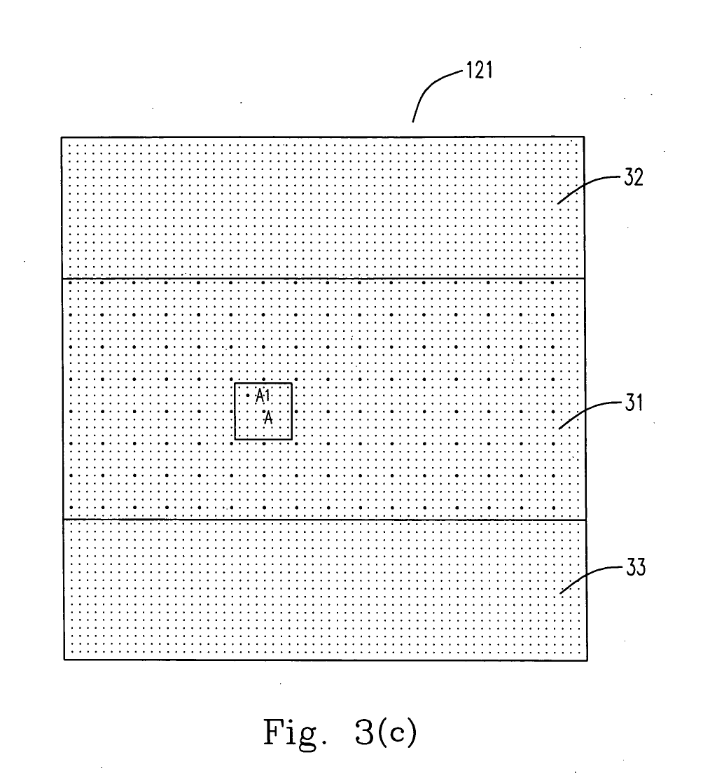

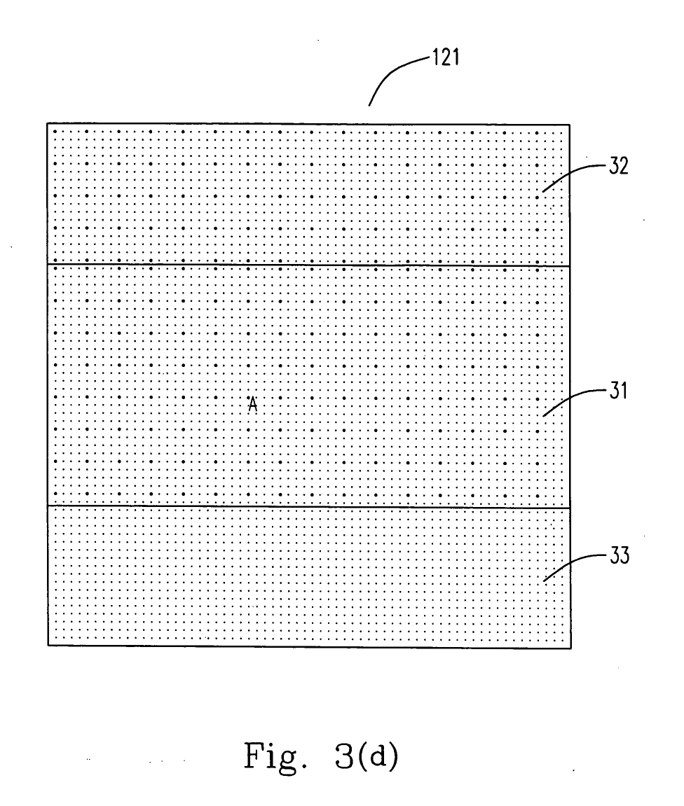

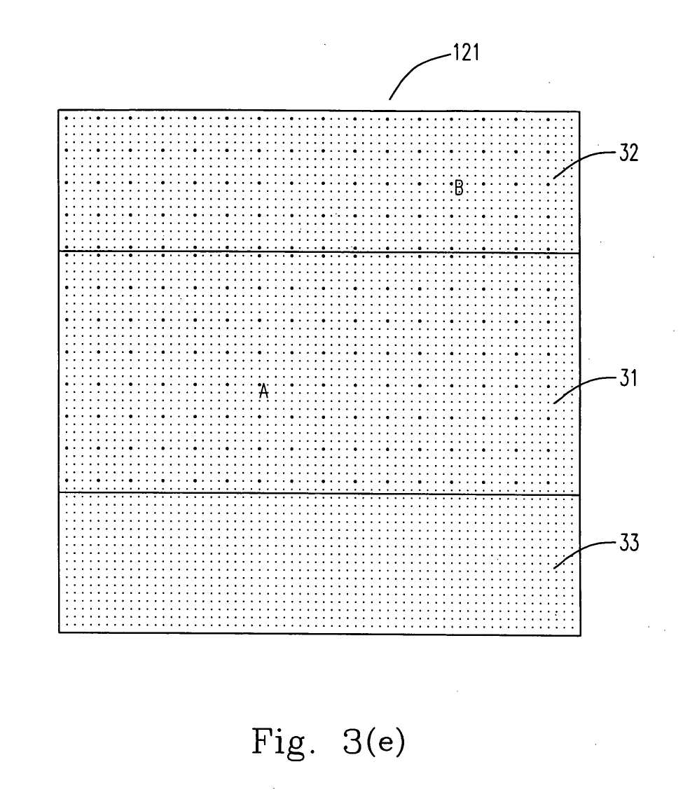

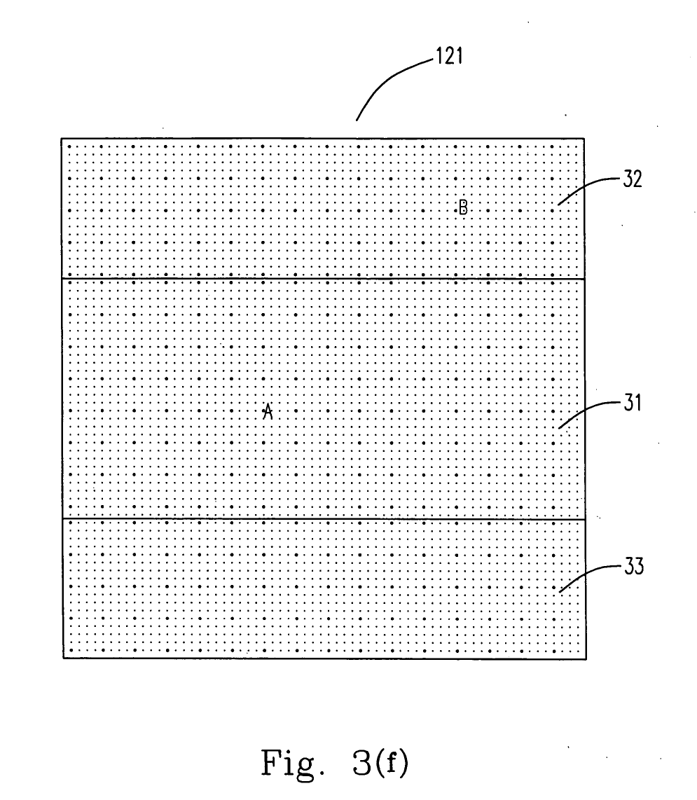

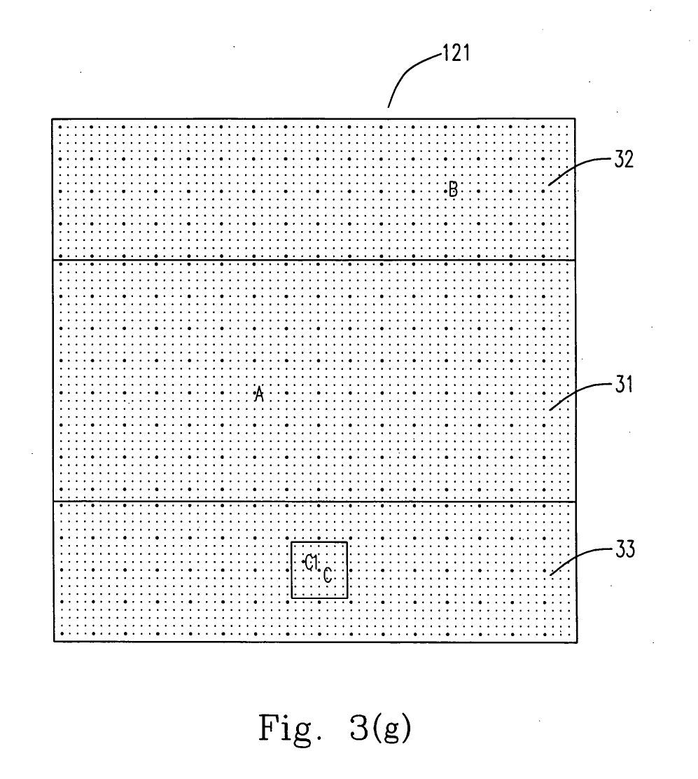

Please refer to FIGS. 3(a)˜3(g) and FIG. 1. FIGS. 3(a)˜3(g) show the steps of the block matching method according to a preferred embodiment of the present invention. The steps of the block matching method according to the present invention will be illustrated in detail as follows.

At first, the search window 121 of the reference frame 12 as shown in FIG. 1 is divided into three areas, including a first area 31 in the center thereof, a second area 32 on the upper section thereof and a third area 33 at the lower section thereof, as shown in FIG. 3(a). Then, sampling points are spread every four pixels in the first area 31, as shown in FIG. 3(b). Next, SAD of 16*16 pixels for each sampling point in the first area 31 is calculated so as to obtain a sampling point A having the minimum value of the cost function thereamong.

At this time, it needs to judge whether the sampling point A found in the first area 31 is the sampling point having the minimum value of the cost function in the search window 121 (including the first area 31, the second area 32 and the third area 33), so three judging criteria are proposed therefor. The judging criteria are:
1. the minimum value of the cost function of the sampling point A being less than a first threshold value;
2. the value of the y component of the motion vector of the sampling point A being less than a second threshold value; and
3. the motion vector between the reference frame 12 and another macro block adjacent to the macro block in the current frame 13 extremely approaching zero.

If the judging criteria 1 and 2 are both satisfied, the sampling point A in the first area 31 is confirmed as the best sampling point. Certainly, the sampling point A in the first area 13 is also confirmed as the best sampling point if the judging criteria 1, 2 and 3 are all satisfied. It is to be noted that the above three judging criteria are presented herein for the purpose of illustration only. One skilled in the art can employ other judging criteria to judge whether the sampling point A in the first area 31 is actually the best sampling point among the three areas 31, 32 and 33.

When the sampling point A in the first area 31 is confirmed as the best sampling point, the subsequent blocking matching will be proceeded. That is, each sampling point within the square block of 7*7 pixels which centers around the sampling point A is calculated so as to obtain a sampling point A1 having the minimum value of the cost function within the square block of 7*7 pixels, as shown in FIG. 3(c). The sampling point A1 can be used for generating the motion vector for the corresponding macro block in the current frame 13. Therefore, the blocking matching is finished and the block matching for the second area 32 and the third area 33 is not proceeded.

If the sampling point A in the first area 31 is not satisfied with the judging criteria 1 and 2 (or the judging criteria 1, 2 and 3), it indicates that the sampling point A is unable to be confirmed as the best sampling point in the search window 121. At this time, the blocking matching for the second area 32 and the third area 33 has to be proceeded. Similarly, the block matching for the second area 32 is to spread one sampling point every four pixels in the second area 32, as shown in FIG. 3(d). Then, SAD of 16*16 pixels for each sampling point in the second area 32 is calculated so as to obtain a sampling point B having the minimum value of the cost function, as shown in FIG. 3(e). The block matching for the third area 33 is proceeded by using the above method so as to obtain a sampling point C having the minimum value of the cost function, as shown in FIGS. 3(f) and 3(g).

Afterwards, a final sampling point from the sampling point A, the sampling point B and the sampling point C is obtained, wherein the final sampling point has a minimum value among the minimum value of the cost function of the sampling point A, the minimum value of the cost function of the sampling point B and the minimum value of the cost function of the sampling point C. In this embodiment, it is assumed that the final sampling point is the sampling point C (certainly, the final sampling point might still be the sampling point A). At last, each sampling point within the square block of 7*7 pixels which centers around the sampling point C is calculated so as to obtain a sampling point C1 having the minimum value of the cost function within the square block of 7*7 pixels, as shown in FIG. 3(g). The sampling point C1 can be used for generating the motion vector for the corresponding macro block in the current frame 13, and thus the blocking matching is finished.

In view of the aforesaid, the present invention is characterized in that the search window 121 is divided into three areas 31, 32 and 33. In the application of images moving in the horizontal direction, the first area located in the center of the search window is searched first, and then a few judging criteria are designed to judge whether the sampling point obtained from the first area 31 represents the best sampling point in the entire search window 121. If so, the search for other two areas 32 and 33 will not be proceeded. If not, the search for the other two areas 32 and 33 will be proceeded so as to obtain the best sampling point in the entire search window 121.

Hence, spreading one sampling point every four pixels to proceed SAD calculations, three judging criteria and the square block of 7*7 pixels centering around the sampling point are all preferred embodiments of the present invention. One skilled in the art can employ other methods to replace the way of spreading one sampling point every four pixels, e.g. the conventional Diamond search. Furthermore, other calculation method can also be employed to calculate the value of the cost function, e.g. MAE. Besides, the three judging criteria can be modified based on actual needs. The square block of 7*7 pixels centering around the sampling point is in light of spreading one sampling point every four pixels, which is also alternative, e.g. spreading one sampling point every five pixels. The advantage of spreading one sampling point every four pixels lies in that the bit width of the computer bus is always the power of 2, so spreading one sampling point every 2² (=4) pixels, every 2³ pixels and so on is more advantageous to shorten the operation time. However, the above values can not be used for limiting the form of the present invention.

In conclusion, the block matching method according to the present invention is aimed at the characteristic of the motion vector required for the hand-shaking compensation for DIS, and utilizes the variation of frames generated from the digital camera operation to divide the search window into three areas, in which the search for the motion vector is initially performed from the center area. This not only acquires the accurate motion vector that meets the demand of the hand-shaking compensation, but effectively shortens the operation time since it is possible to find the desired macro block in the center area.

Accordingly, the present invention can effectively solve the problems and drawbacks in the prior arts, and thus it fits the demands of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A block matching motion estimation method for obtaining a motion vector between a macro block in a current frame and a best match block in a reference frame, comprising steps of:
dividing a search window of said reference frame into a first area, a second area and a third area, wherein said first area is located between said second area and said third area; and
searching initially from said first area for said motion vector.

2. The method as claimed in claim 1, wherein said reference frame and said current frame respectively comprise a plurality of macro blocks.

3. The method as claimed in claim 1, wherein said current frame is subsequent to said reference frame in time domain.

4. The method as claimed in claim 1, wherein said search window of said reference frame has a size greater than that of said macro block in said current frame.

5. The method as claimed in claim 1, wherein said first area has a size greater than one of those of said second area and said third area.

6. The method as claimed in claim 1, wherein said search step for said motion vector comprises sub-steps of:
(a) finding a sampling point A having a minimum value of a cost function in said first area;
(b) determining whether said sampling point A is a sampling point having a minimum value of a cost function in said search window according to a plurality of judging criteria;
(c) calculating each sampling point within a first square block of O*P pixels which centers around said sampling point A if said judging criteria are satisfied to obtain a sampling point A1 having a minimum value of a cost function within said first square block of O*P pixels so as to obtain said motion vector;
(d) finding a sampling point B having a minimum value of a cost function in said second area and a sampling point C having a minimum value of a cost function in said third area if said judging criteria are not satisfied;
(e) obtaining a final sampling point from said sampling point A, said sampling point B and said sampling point C, wherein said final sampling point has a minimum value among said minimum value of said cost function of said sampling point A, said minimum value of said cost function of said sampling point B and said minimum value of said cost function of said sampling point C; and
(f) calculating each sampling point within a second square block of O*P pixels which centers around said final sampling point to obtain a sampling point F having a minimum value of a cost function within said second square block of O*P pixels so as to obtain said motion vector.

7. The method as claimed in claim 6, wherein said step (a) is performed by spreading a sampling point every X pixels in said first area and then calculating a sum of absolute difference (SAD) of M*N pixels for each said sampling point in said first area so as to obtain said sampling point A having said minimum value of said cost function.

8. The method as claimed in claim 7, wherein A is equal to 4.

9. The method as claimed in claim 7, wherein M and N are both equal to 16.

10. The method as claimed in claim 6, wherein said judging criteria comprise:
said minimum value of said cost function of said sampling point A being less than a first threshold value; and
a value of a y component of a motion vector of said sampling point A being less than a second threshold value.

11. The method as claimed in claim 6, wherein said judging criteria further comprise:
a motion vector between said reference frame and another macro block adjacent to said macro block in said current frame extremely approaching zero.

12. The method as claimed in claim 6, wherein O and P are both equal to 7.

13. The method as claimed in claim 6, wherein said step (d) is performed by spreading a sampling point every X pixels in said second area and then calculating a sum of absolute difference (SAD) of M*N pixels for each said sampling point in said second area so as to obtain said sampling point B having said minimum value of said cost function.

14. The method as claimed in claim 6, wherein said step (d) is performed by spreading a sampling point every X pixels in said third area and then calculating a sum of absolute difference (SAD) of M*N pixels for each said sampling point in said third area so as to obtain said sampling point C having said minimum value of said cost function.

15. A digital image stabilization system having a block matching motion estimation method executed therein for obtaining a motion vector between a macro block in a current frame and a best match block in a reference frame, characterized in that:
said reference frame comprises a search window divided into a first area, a second area and a third area, wherein said first area is located between said second area and said third area; and
a search for said motion vector is initially performed from said first area.
